(19) United States
(12) Patent Application Publication
(10) Pub. No.: US 2017/0146778 A1
(43) Pub. Date: May 25, 2017

(54) WIDE-ANGLE LENS

(71) Applicant: Somo Vision Co., Ltd., Gangwon-Do (KR)

(72) Inventors: Jae Cheol Jeong, Gyeonggi-Do (KR); Hoe Sun Lee, Seoul (KR); Jong Sang Jung, Gyeonggi-Do (KR); Seung Chong Shin, Seoul (KR); Hyung Kyu Park, Gyeonggi-Do (KR)

(21) Appl. No.: 15/317,890

(22) PCT Filed: Jun. 8, 2015
(86) PCT No.: PCT/KR2015/005734

§ 371 Date: Jan. 31, 2017

(30) Foreign Application Priority Data
Jun. 9, 2014 (KR) 10-2014-0069611
May 15, 2015 (KR) 10-2015-0068098

(51) Int. Cl. G02B 13/06; G02B 13/18; G02B 9/62

(52) U.S. Cl. CPC G02B 13/06; G02B 9/62; G02B 13/18

(57) ABSTRACT

The present invention comprises: a first lens having a negative refractive index, the first lens being a meniscus lens wherein the surface facing an object is convex toward the object and the surface facing an image is concave; a second lens having a negative refractive index, the second lens being a meniscus lens wherein the surface facing the first lens is convex toward the first lens and the surface facing the image is concave; a third lens having a negative refractive index, the third lens being a lens wherein the surface facing the image is concave; a fourth lens having a positive refractive index, wherein both surfaces are concave; a fifth lens which is located behind the fourth lens and configured in such a way that a third unit lens having a positive refractive index is bonded with a fourth unit lens having a negative refractive index; and a sixth lens which is biconvex and has a positive refractive index.

### TECHNICAL FIELD

The present invention relates to a wide-angle lens and, more particularly, to a wide-angle lens which may be applied to a camera having an angle of view of 180 degrees or more.

### BACKGROUND ART

In order to capture and store a sports scene, more specifically, a motion of a player who dynamically acts, to use a wide-angle lens having a wide angle of view as much as possible is preferred.

Such a wide-angle lens module includes lenses having the number of sheets (e.g., 8 sheets or more) greater than a common lens module in order to implement a wide angle of view, and could implement a wide angle of view (e.g., 180 degrees or more).

However, such a wide-angle lens module is likely to have distortion phenomenon due to a relatively large number of lenses and to have a vignetting phenomenon in which the edge of a captured image is cut off.

Furthermore, most of the places where a sports image is obtained are the fields. In order to capture a proper image, it is necessary to secure reliability of a lens because a photographer moves a lot.

An example of a prior art of the present invention may include Korean Patent Application Publication No. 2013-0056574.

### DISCLOSURE

### Technical Problem

The present invention has been made to solve the need and an object of the present invention is to provide a wide-angle lens which may be applied to a camera having an angle of view of 180 degrees or more.

Furthermore, an object of the present invention is to provide a wide-angle lens including a less number of lenses.

Furthermore, an object of the present invention is to provide a wide-angle lens capable of securing reliability even in outdoor activities.

### Technical Solution

To achieve the above objects, a wide-angle lens according to the present invention includes:

a first lens having a negative (−) refractive index, the first lens being a meniscus lens in which a surface facing an object is convex toward the object and a surface facing an image is concave;

a second lens disposed behind the first lens and having a negative (−) refractive index, the second lens being a meniscus lens in which a surface facing the first lens is convex toward the first lens and a surface facing the image is concave;

a third lens disposed behind the second lens and having a negative (−) refractive index, the third lens being a lens in which a surface facing the image is concave;

a fourth lens disposed behind the third lens and having a positive (+) refractive index, both surfaces of the fourth lens being convex;

a fifth lens disposed behind the fourth lens, but disposed toward the object, the fifth lens being configured by jointing a third unit lens having a positive (+) refractive index and a fourth unit lens having a negative (−) refractive index together; and

a sixth lens disposed behind the fifth lens and having a positive (+) refractive index, both surfaces of the sixth lens being convex.

### Advantageous Effects

In accordance with the present invention configured as described above, there are advantages in that an angle of view of 180 degrees or more can be achieved, a less number of lenses can be included, and reliability can be secured even in outdoor activities.

### DESCRIPTION OF DRAWINGS

FIG. 1 is a cross-sectional view showing the configuration of a wide-angle lens according to a first embodiment of the present invention.

FIG. 2 is a graph showing the spherical aberration and astigmatism of the wide-angle lens shown in FIG. 1.

FIG. 3 is a graph showing a degree of distortion of the wide-angle lens shown in FIG. 1.

FIG. 4 is a graph showing the modulation transfer function (MTF) of the wide-angle lens shown in FIG. 1.

FIG. 5 is a cross-sectional view showing the configuration of a wide-angle lens according to a second embodiment of the present invention.

FIG. 6 is a graph showing the spherical aberration and astigmatism of the wide-angle lens shown in FIG. 5.

FIG. 7 is a graph showing the spherical aberration and astigmatism of the wide-angle lens shown in FIG. 5.

FIG. 8 is a graph showing the MTF of the wide-angle lens shown in FIG. 5.

FIG. 9 is a cross-sectional view showing the configuration of a wide-angle lens according to a third embodiment of the present invention.

FIG. 10 is a graph showing the spherical aberration and astigmatism of the wide-angle lens shown in FIG. 9.

FIG. 11 is a graph showing the MTF of the wide-angle lens shown in FIG. 9.

FIG. 12 is a cross-sectional view showing the configuration of a wide-angle lens according to a fourth embodiment of the present invention.

FIG. 13 is a graph showing the spherical aberration and astigmatism of the wide-angle lens shown in FIG. 12.

FIG. 14 is a graph showing the MTF of the wide-angle lens shown in FIG. 12.

FIG. 15 is a cross-sectional view showing the configuration of a wide-angle lens according to a fifth embodiment of the present invention.

FIG. 16 is a graph showing the spherical aberration and astigmatism of the wide-angle lens shown in FIG. 15.

FIG. 17 is a graph showing the MTF of the wide-angle lens shown in FIG. 15.

### MODE FOR INVENTION

Hereinafter, preferred embodiments of the present invention are described in detail with reference to the accompanying drawings.

### First Embodiment

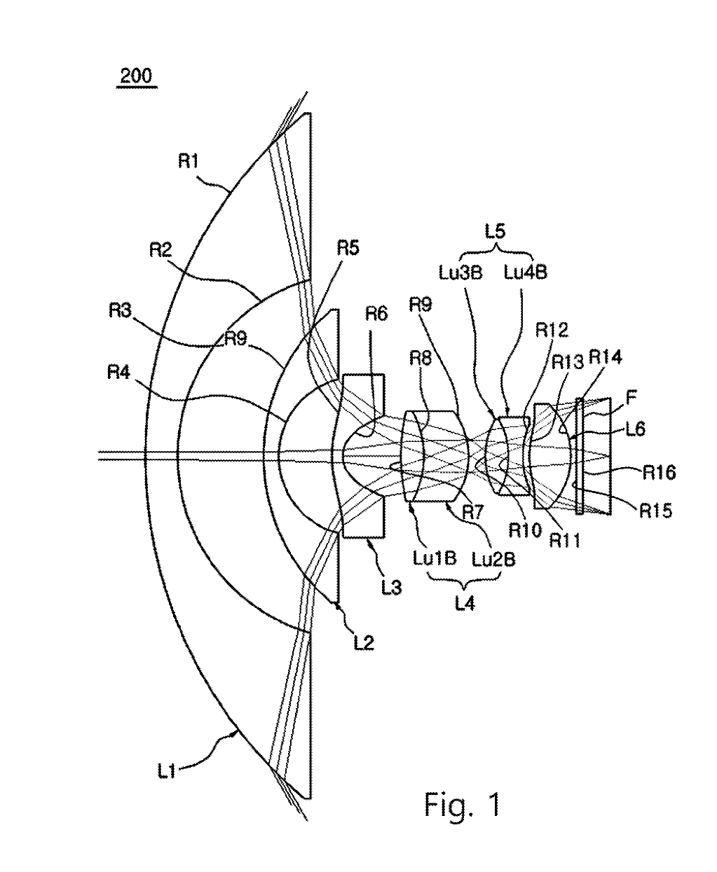

FIG. 1 is a cross-sectional view showing the configuration of a wide-angle lens according to a first embodiment of the present invention.

Referring to FIG. 1, the wide-angle lens 200 according to the first embodiment of the present invention includes a first lens L1, a second lens L2, a third lens L3, a fourth lens L4, a fifth lens L5 and a sixth lens L6. Furthermore, the wide-angle lens 200 according to the present invention may further include a filter.

First, the first lens L1, the second lens L2, the third lens L3, the fourth lens L4, the fifth lens L5, the sixth lens L6 and the filter F, that is, elements of the present invention, may be disposed within a cylindrical main scope tube (not shown) having a specific diameter and length.

Furthermore, a fixed ring for fixing the lenses and the filter may be disposed within the main scope tube.

Furthermore, in the detection distance of the wide-angle lens 200 according to the present invention, an angle of view may be set to 180 degrees or more.

The first lens L1, the second lens L2, the third lens L3, the fourth lens L4, the fifth lens L5, the sixth lens L6 and the filter F are sequentially disposed from one end to the other end within the main scope tube.

The first lens L1 is concave meniscus type concave lens in which a surface R1 facing an object is convex and a surface R2 facing an image is concave. Both surfaces R1 and R2 may be a spherical surface. The first lens L1 has a negative (−) refractive index.

Furthermore, the diameter of the first lens L1 may be greater than that of the second lens L2. It is preferred that the edge of the backside R2 of the first lens L1, that is, the surface facing the image, is processed in a plane form. It is preferred that the concave portion of the surface R2 of the first lens L1 that faces the image is greater than the diameter of the second lens L2.

The second lens L2 is a concave meniscus type concave lens in which both surfaces, that is, a surface R3 that faces the first lens L1 and on which light is incident is convex and a surface R4 that faces the image and that transmits light is concave. The second lens L2 has a negative (−) refractive index.

It is preferred that the focal distance of the first lens L1 and the second lens L2 satisfy [Equation 1] below.

1.5<|f1/f2|<4.0 [Equation 1]

f1: the focal distance of the first lens

f2: the focal distance of the second lens

The third lens L3 faces the second lens L2, and is a concave double-concave lens in which a surface R5 on which light is incident is concave and a surface R6 that faces the image and that transmits light is concave. The third lens L3 has a negative (−) refractive index. It is preferred that the diameter of the third lens L3 is smaller than that of the second lens L2. The edge of the backside R6 of the third lens L3, that is, the surface facing the image, may be processed in a plane form. Any one of the light incidence surface and light transmission surface of the third lens L3 may be formed in an aspherical surface form.

It is preferred that the third lens L3 satisfies [Equation 2] below with respect to a coefficient of thermal expansion.

|A3|>1.6×10⁻⁵ [Equation 2]

A3: a coefficient of thermal expansion of the third lens

The fourth lens L4 has a positive (+) refractive index. The fourth lens L4 includes a first unit lens LU1B having a positive (+) refractive index and a second unit lens LU2B having a negative (−) refractive index. The absolute value of the refractive index of the first unit lens LU1B may be greater than the absolute value of the refractive index of the second unit lens LU2B.

In this case, the first unit lens LU1B may be a double-convex lens. Furthermore, the second unit lens LU2B may be a meniscus type concave lens in which a surface facing the object is concave and a surface facing an image is convex.

The fifth lens L5 has a positive (+) refractive index. The fifth lens L5 includes a first unit lens LU1A having a positive (+) refractive index and a second unit lens LU2A having a negative (−) refractive index. The diameter of the fifth lens L5 may be smaller than the diameter of the fourth lens L4.

The first unit lens LU1A is a double-convex lens having both surfaces R9 and R10 convex and has a positive (+) refractive index. The second unit lens LU2A is a double-concave lens having both surfaces R11 and R12 concave and has a negative (−) refractive index.

It is preferred that the absolute value of the refractive index of the first unit lens LU1A has a greater than the absolute value of the refractive index of the second unit lens LU2A.

In this case, it is preferred that the fifth lens L5 satisfies [Equation 3] and [Equation 4] below.

20<v53−v54<40 [Equation 3]

v53: the Abbe number of the third unit lens of the fifth lens

v54: the Abbe number of the fourth unit lens of the fifth lens

20<v51−v52<40 [Equation 4]

v51: the Abbe number of the first unit lens of the fifth lens

v52: the Abbe number of the second unit lens of the fifth lens

The sixth lens L6 is a double-convex lens having both surfaces convex and has a positive (+) refractive index.

In this case, the center of the light incidence surface of the sixth lens L6 is convex, and the outer circumference of the sixth lens L6 may be formed to have a concave cross section.

Furthermore, it is preferred that the sixth lens L6 satisfies [Equation 5] below.

|A6|>1.6×10⁻⁵ [Equation 5]

A6: a coefficient of thermal expansion of the sixth lens

Meanwhile, it is preferred that each of the third lens L3 and the sixth lens L6 satisfies [Equation 6] below.

|n3−n6|<0.2 [Equation 6]

n3: the refractive index of the third lens

n6: the refractive index of the sixth lens

It is preferred that each of the optical surfaces of the wide-angle lens shown in FIG. 1 has numerical values written in [Table 1] and [Table 2] below.

[Table 1] shows the basic data of the elements of the wide-angle lens.

TABLE 1
Basic lens data

| Surface | Curvature | Surface | Refractive | Index of |
|---|---|---|---|---|
| number | radius | interval | index | dispersion |
| Object | Infinity | Infinity | | |
| R1 | 20.66371 | 1.500000 | 1.734 | 51.05 |
| R2 | 8.50754 | 3.975497 | | |
| R3 | 8.84309 | 0.700000 | 1.697 | 55.46 |
| R4 | 3.67428 | 2.471184 | | |
| R5 | 5.56486 | 0.493941 | 1.545 | 56.00 |
| R6 | 1.19930 | 2.674362 | | |
| R7 | 8.44654 | 1.082182 | 1.717 | 29.50 |
| R8 | −4.20971 | 2.060292 | 1.487 | 70.44 |
| R9 | −3.43828 | 0.100000 | | |
| Iris | Infinity | 0.845268 | | |
| R10 | 3.49431 | 1.117202 | 1.757 | 47.71 |
| R11 | −2.50000 | 0.450000 | 1.9228 | 20.88 |
| R12 | 3.70494 | 0.297017 | | |
| R13 | 3.79428 | 1.934281 | 1.545 | 56.00 |
| R14 | −2.33794 | 0.243757 | | |
| R15 | Infinity | 0.300000 | 1.5168 | 64.16 |
| R16 | Infinity | 1.259205 | | |
| Image | Infinity | 0.000000 | | |

In this case, f1: −20.75

f2: −9.53

v61: 47.71

v62: 20.88

n1: 1.734

v1: 51.05

[Table 2] shows the aspherical surface coefficient values of the lenses included in the present invention.

TABLE 2

| Aspherical | | | | | | |
|---|---|---|---|---|---|---|
| surface | | | | | | |
| coefficient | K | A | B | C | D | E |
| R5 | −0.0000000 | −0.462896E−02 | −0.894495E−04 | 0.562772E−05 | −0.914904E−09 | |
| R6 | −0.818121 | 0.181067E−01 | −0.522518E−04 | 0.498218E−03 | −0.309642E−04 | |
| R14 | −2.233116 | −0.184892E−01 | 0.488295E−02 | −0.126801E−02 | 0.00000E+00 | |
| R15 | −2.558085 | −0.159207E−01 | 0.572555E−02 | −0.275191E−02 | 0.687028E−03 | −0.830046E−04 |

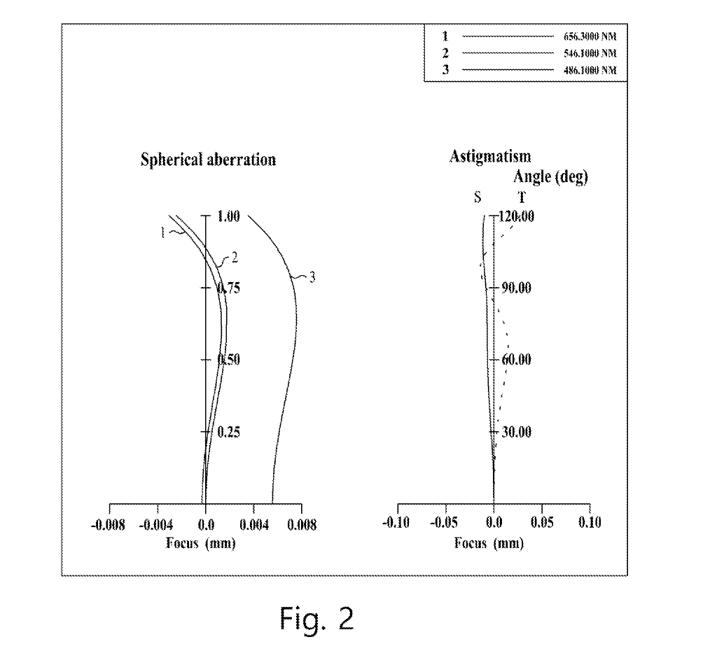

Performance of the present invention configured as described above has been described in FIGS. 2 to 4.

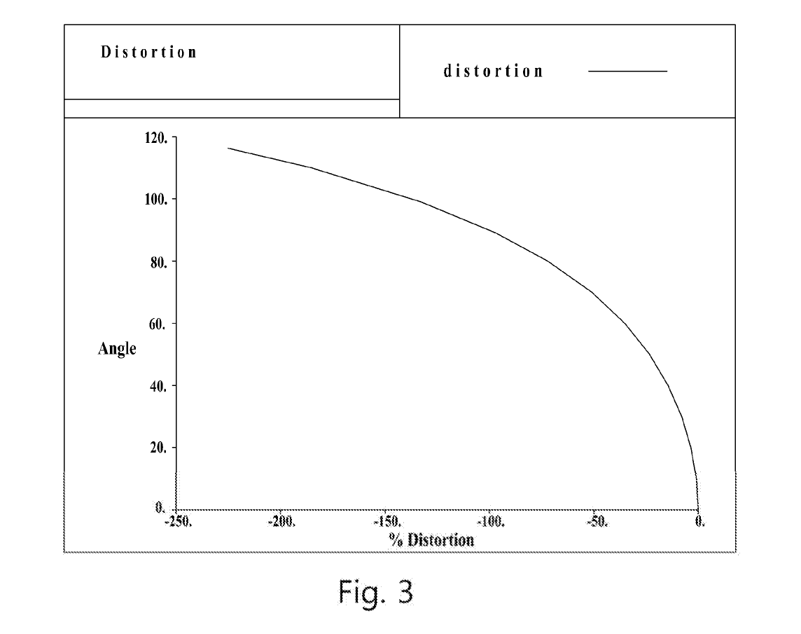

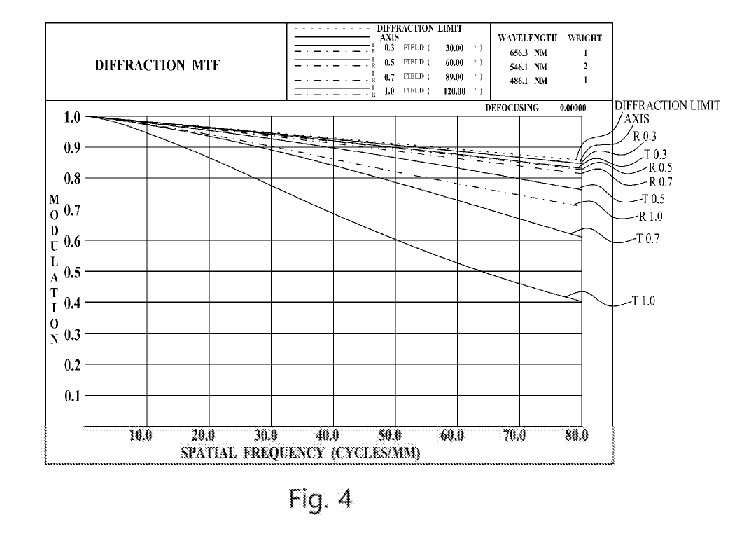

FIG. 2 is a graph showing the spherical aberration and astigmatism of the wide-angle lens shown in FIG. 1, and FIG. 3 is a graph showing a degree of distortion of the wide-angle lens shown in FIG. 1. Furthermore, FIG. 4 is a graph showing the modulation transfer function (MTF) of the wide-angle lens shown in FIG. 1.

### Second Embodiment

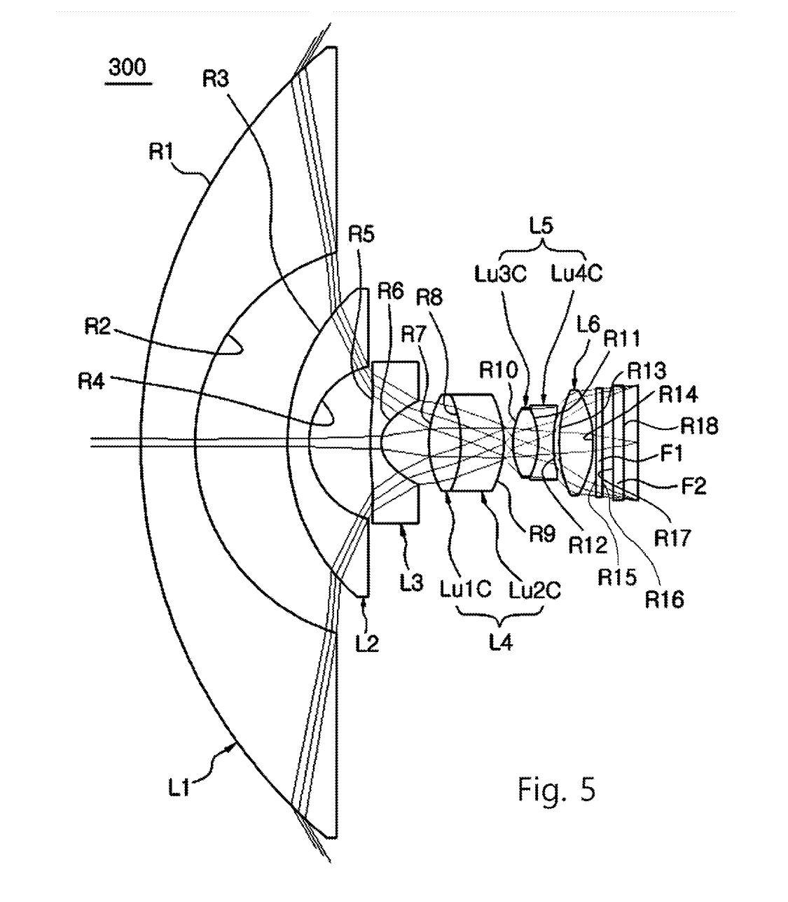

FIG. 5 is a cross-sectional view showing the configuration of a wide-angle lens according to a second embodiment of the present invention.

Referring to FIG. 5, the wide-angle lens 300 according to the second embodiment of the present invention includes a first lens L1, a second lens L2, a third lens L3, a fourth lens L4, a fifth lens L5, and a sixth lens L6. Furthermore, the wide-angle lens 300 according to the present invention may further include first and second filters F1 and F2.

A detailed description of the same elements as those of the previous embodiment is omitted.

It is preferred that each of the optical surfaces of the wide-angle lens shown in FIG. 5 satisfies numerical values described in [Table 3] and [Table 4].

[Table 3] shows the basic data of the elements of the wide-angle lens.

TABLE 3
Basic lens data

| Surface | Curvature | Surface | Refractive | Index of |
|---|---|---|---|---|
| number | radius | interval | index | dispersion |
| Object | Infinity | Infinity | | |
| R1 | 24.06354 | 2.527294 | 1.734 | 51.49 |
| R2 | 9.31114 | 4.320686 | | |
| R3 | 9.66177 | 1.000000 | 1.697 | 48.51 |
| R4 | 3.69055 | 2.863542 | | |
| R5 | 14.54159 | 0.501735 | 1.545 | 56.00 |
| R6 | 1.26298 | 2.219148 | | |
| R7 | 4.52520 | 1.501599 | 1.717 | 29.51 |
| R8 | −5.50055 | 1.999277 | 1.497 | 81.59 |
| R9 | −4.88059 | 0.106267 | | |
| Iris | Infinity | 0.845268 | | |
| R10 | 3.48844 | 1.061019 | 1.756 | 45.59 |
| R11 | −2.40205 | 0.400000 | 1.923 | 20.88 |
| R12 | 3.85047 | 0.247588 | | |
| R13 | 3.45174 | 1.576161 | 1.545 | 56.00 |
| R14 | −2.33513 | 0.243757 | | |
| R15 | Infinity | 0.300000 | 1.5168 | 64.16 |
| R16 | Infinity | 0.500000 | | |
| R17 | Infinity | 0.500000 | 1.5168 | 64.16 |
| R18 | Infinity | 0.666901 | | |
| Image | Infinity | 0.000000 | | |

In this case, f1: −22.27

f2: −9.18

v61: 51.49

v62: 48.51

n1: 1.734

v1: 51.49

[Table 4] shows the aspherical surface coefficient values of the lenses included in the present invention.

TABLE 4

| Aspherical | | | | | | |
|---|---|---|---|---|---|---|
| surface | | | | | | |
| coefficient | K | A | B | C | D | E |
| R5 | −0.0000000 | −0.271574E−02 | −0.442915E−04 | 0.857830E−05 | −0.290445E−06 | |
| R6 | −0.792041 | 0.525946E−01 | −0.298923E−02 | 0.524824E−03 | −0.903958E−04 | |
| R13 | −3.717290 | −0.141238E−01 | 0.598222E−02 | −0.110302E−02 | 0.00000E+00 | |
| R14 | −4.478213 | −0.288038E−01 | 0.837859E−02 | −0.204318E−02 | 0.538155E−03 | −0.830046E−04 |

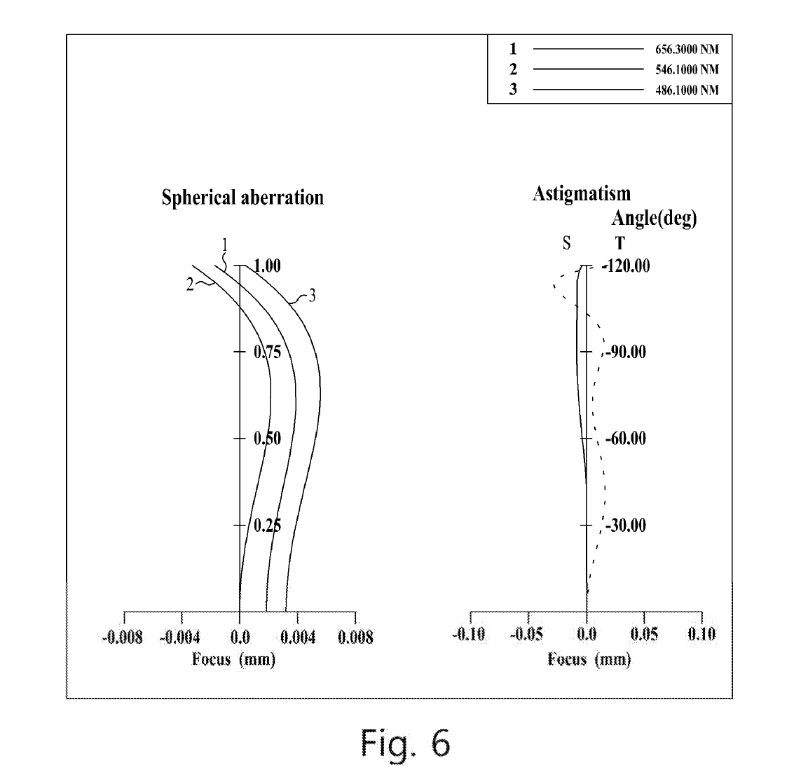

Performance of the present invention configured as described above is described in FIGS. 6 to 8.

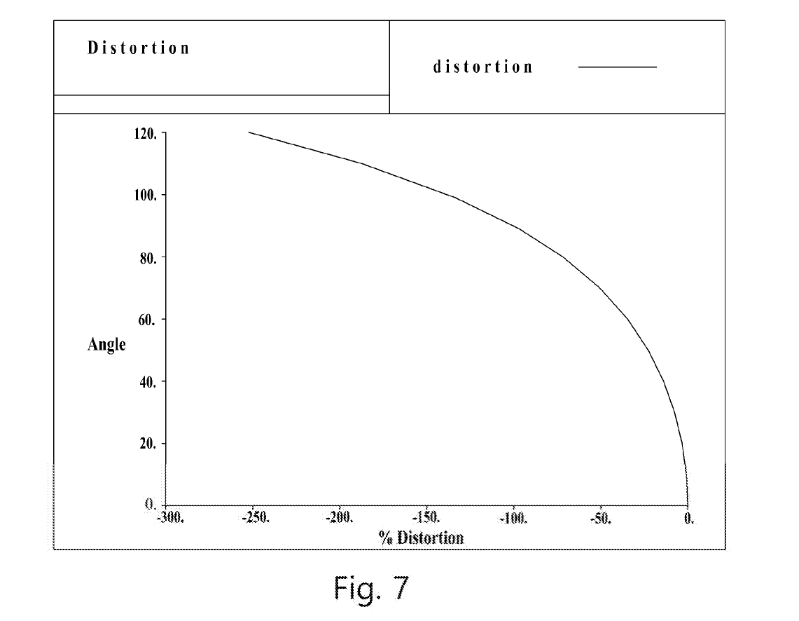

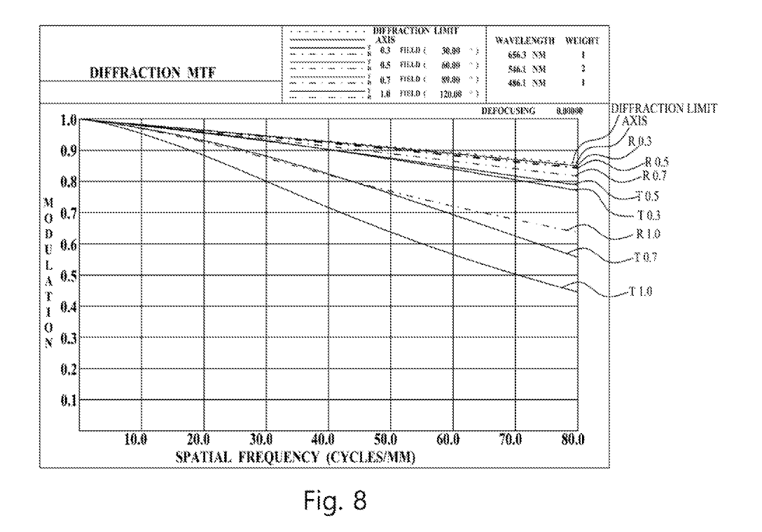

FIG. 6 is a graph showing the spherical aberration and astigmatism of the wide-angle lens shown in FIG. 5, and FIG. 7 is a graph showing the spherical aberration and astigmatism of the wide-angle lens shown in FIG. 5. Furthermore, FIG. 8 is a graph showing the MTF of the wide-angle lens shown in FIG. 5.

In the aforementioned embodiments 1 and 2, the aspherical surface may be converted by [Equation 7] below.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad [ Equation 7 ]$$

In this case, c=1/radius.

Furthermore, the Abbe number of the lens may be converted by [Equation 8] below.

v#=(nd−1)/(nF−nC) [Equation 8]

#: the serial number of the lens

nd: a refractive index in a wavelength 587 nm

nF: a refractive index in a wavelength 486 nm

nC: a refractive index in a wavelength 656 nm

### Third Embodiment

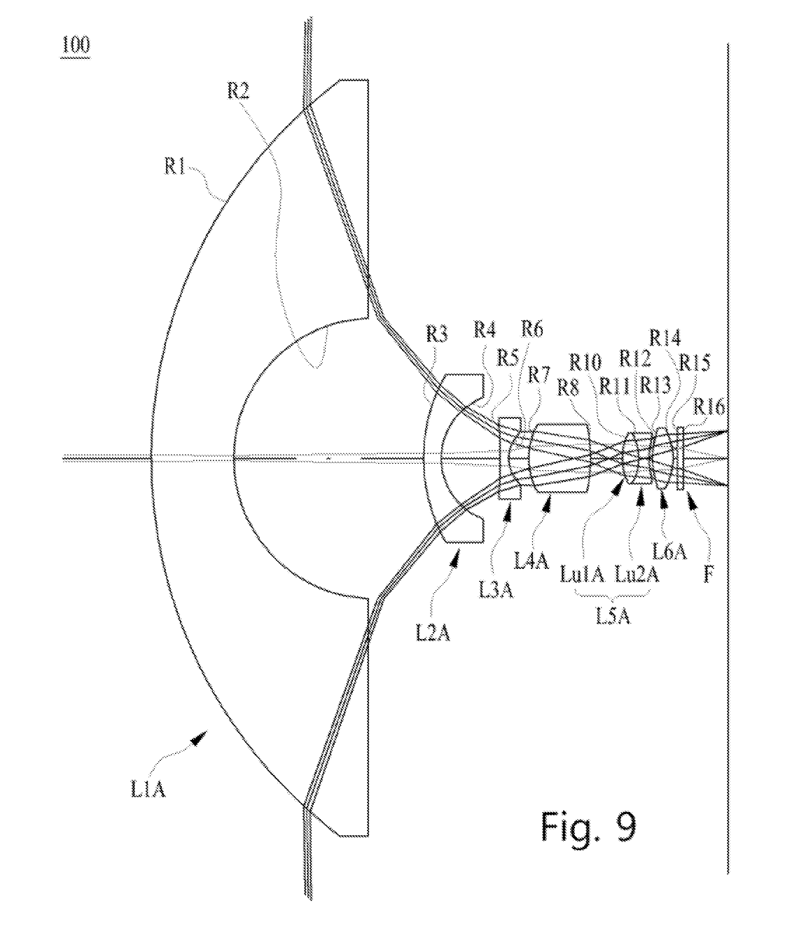

FIG. 9 is a cross-sectional view showing the configuration of a wide-angle lens according to a third embodiment of the present invention.

Referring to FIG. 9, the wide-angle lens 100 according to the third embodiment of the present invention includes a first lens L1A, a second lens L2A, a third lens L3A, a fourth lens L4A, a fifth lens L5A and a sixth lens L6A. Furthermore, the wide-angle lens 100 according to the present invention may further include a filter F.

First, the first lens L1A, the second lens L2A, the third lens L3A, the fourth lens L4A, the fifth lens L5A, the sixth lens L6A and the filter F, that is, elements of the present invention, may be disposed within a cylindrical main scope tube (not shown) having a specific diameter and length.

Furthermore, a fixed ring for fixing the lenses and the filter may be disposed within the main scope tube.

Furthermore, the detection distance of the wide-angle lens 100 according to the present invention may be set as an angle of view of 180 degrees or more.

The first lens L1A, the second lens L2A, the third lens L3A, the fourth lens L4A, the fifth lens L5A, the sixth lens L6A and the filter F are sequentially disposed from one end to the other end within the main scope tube.

The first lens L1A is a concave meniscus type concave lens in which a first surface R1 facing an object is convexly formed toward the object and a second surface R2 facing the image is concave. Both surfaces R1 and R2 may be a spherical surface. The first lens L1A has a negative (−) refractive index.

The diameter of the first lens L1A may be greater than the diameter of the second lens L2A to be described later. It is preferred that the edge of the backside R2 of the first lens L1A, that is, the surface facing the image, is processed in a plane form. It is preferred that the concave portion of the surface R2 of the first lens L1A that faces the image has a greater diameter than the second lens L2A.

It is preferred that the refractive index of the first lens L1A satisfies [Equation 9] below. In this case, it is preferred that a criterion wavelength for measuring the refractive index is 587 nm.

1.55<n1<1.85 [Equation 9]

n1: the refractive index of the first lens in a wavelength 587 nm

It is preferred that the Abbe number of the first lens L1A satisfies [Equation 10] below.

40<v1<80 [Equation 10]

v1: the Abbe number of the first lens

The first lens L1A may include optical glass or extra dispersion glass having a high refractive index.

The second lens L2A is disposed in the rear of the first lens L1A. In the second lens L2A, it is preferred that the third surface R3 of the second lens L2A that faces the first lens L1A is convex with respect to the first lens L1A and a fourth surface R4 facing an image is concave. It is preferred that the second lens L2A is a meniscus lens. Furthermore, the second lens L2A has a negative (−) refractive index.

It is preferred that the focal distance of the first lens L1A and the second lens L2A satisfies [Equation 11] below.

1.5<|f1/f2|<4.0 [Equation 11]

f1: the focal distance of the first lens

f2: the focal distance of the second lens

The third lens L3A is disposed in the rear of the second lens L2A. The third lens L3A is a concave lens in which a sixth surface R6 facing the image is concave. The fifth surface R5 of the third lens L3A that faces the object may be concave.

The third lens L3A has a negative (−) refractive index. It is preferred that the diameter of the third lens L3A is smaller than the diameter of the second lens L2A.

The edge of the backside R6 of the third lens L3A, that is, the surface facing the image, may be processed in a plane form.

Any one of the fifth surface R5 and sixth surface R6 of the third lens L3A may be an aspherical surface. In the present embodiment, each of the fifth surface R5 and the sixth surface R6 is an aspherical surface, and the aspherical surface coefficient of each of the fifth surface R5 and the sixth surface R6 is written in [Table 6].

The fourth lens L4A is disposed in the rear of the third lens L3A.

The fourth lens L4A is a double-convex lens in which a seventh surface R7 facing the object and an eighth surface R8 facing the image are convex. The fourth lens L4A has a positive (+) refractive index.

The fifth lens L5A is disposed in the rear of the fourth lens L4A.

The fifth lens L5A includes a third unit lens Lu1C that has a positive (+) refractive index and that is disposed to face the object and a fourth unit lens Lu2C that has a negative (−) refractive index and that is disposed to face the image. The fifth lens L5A may be configured by joining the third unit lens Lu1C and the fourth unit lens Lu2C together.

In this case, the third unit lens Lu1C may be a double-convex lens, and the fourth unit lens Lu2C may be a double-concave lens.

The Abbe number of the third unit lens Lu1C and the fourth unit lens Lu2C satisfies [Equation 12] below.

20<v53−v54<40 [Equation 12]

v53: the Abbe number of the third unit lens of the fifth lens

v54: the Abbe number of the fourth unit lens of the fifth lens

The sixth lens L6A is disposed in the rear of the fifth lens L5A. The sixth lens L6A has a positive (+) refractive index. The sixth lens L6A is a double-convex lens having both surfaces convex, and may include one or more aspherical surfaces.

In this case, the fourth lens L4A and the sixth lens satisfy [Equation 13] and [Equation 14] below.

1.0<f4/f6<2.0 [Equation 13]

f4: the focal distance of the fourth lens

f6: the focal distance of the sixth lens

2.0<f6/f<5 [Equation 14]

f: a total focal distance of the wide-angle lens

Meanwhile, it is preferred that the coefficient of thermal expansion of the third lens L3A and the sixth lens L6A satisfies [Equation 15] below.

|A3|>1.6×10−5 [Equation 15]

|A6|>1.6×10−5

A3: a coefficient of thermal expansion of the third lens

A6: a coefficient of thermal expansion of the sixth lens

The filter F transmits light of a specific wavelength that is required by a user. The filter F may be used in various ways depending on a user need.

It is preferred that each of the optical surfaces of the wide-angle lens shown in FIG. 9 has numerical values written in [Table 5] and [Table 6] below. [Table 5] shows the basic data of the elements of the wide-angle lens.

TABLE 5
Basic lens data

| Surface | Curvature | Surface | Refractive | Index of |
|---|---|---|---|---|
| number | radius | interval | index | dispersion |
| Object | Infinity | Infinity | | |
| R1 | 25.73372 | 4.482244 | 1.768 | 72.58 |
| R2 | 7.64738 | 10.331669 | | |
| R3 | 9.17139 | 0.963514 | 1.744 | 44.89 |
| R4 | 3.53103 | 3.211621 | | |
| R5 | −34.01506 | 0.450000 | 1.545 | 56.00 |
| R6 | 1.62247 | 1.102364 | | |
| R7 | 3.76470 | 3.358311 | 1.7173 | 29.50 |
| R8 | −8.69767 | 1.001079 | | |
| Iris | Infinity | 0.738467 | | |
| R10 | 3.14843 | 0.897860 | 1.714 | 47.35 |
| R11 | −2.60000 | 0.546739 | 1.846 | 23.78 |
| R12 | 4.10309 | 0.192124 | | |
| R13 | 3.73975 | 1.123747 | 1.545 | 56.00 |
| R14 | −2.97138 | 0.243767 | | |
| R15 | Infinity | 0.300000 | 1.5168 | 64.16 |
| R16 | Infinity | 2.452206 | | |
| Image | Infinity | 0.000000 | | |

In this case, f1: −15.85

f2: −8.3

f4: 4.11

f6: 3.22

f: 0.8422

v51: 47.35

v52: 23.78

n1: 1.768

v1: 72.58

[Table 6] shows the aspherical surface coefficient values of the lenses included in the present invention.

TABLE 6

| Aspherical | | | | | | |
|---|---|---|---|---|---|---|
| surface | | | | | | |
| coefficient | K | A | B | C | D | E |
| R5 | −0.0000000 | −0.196175E−02 | 0.109171E−04 | 0.126567E−04 | −0.132990E−05 | |
| R6 | −0.645591 | −0.409360E−02 | −0.258670E−02 | 0.501243E−03 | −0.821094E−04 | |
| R13 | −2.459224 | −0.115200E−01 | 0.480578E−02 | −0.127293E−02 | 0.00000E+00 | |
| R14 | −7.419680 | −0.285093E−01 | 0.931166E−02 | −0.185378E−02 | 0.355003E−03 | −0.791790E−04 |

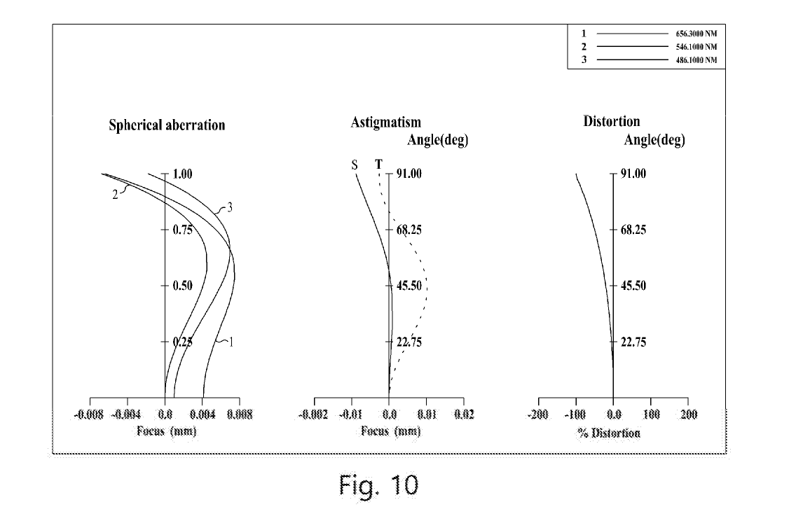

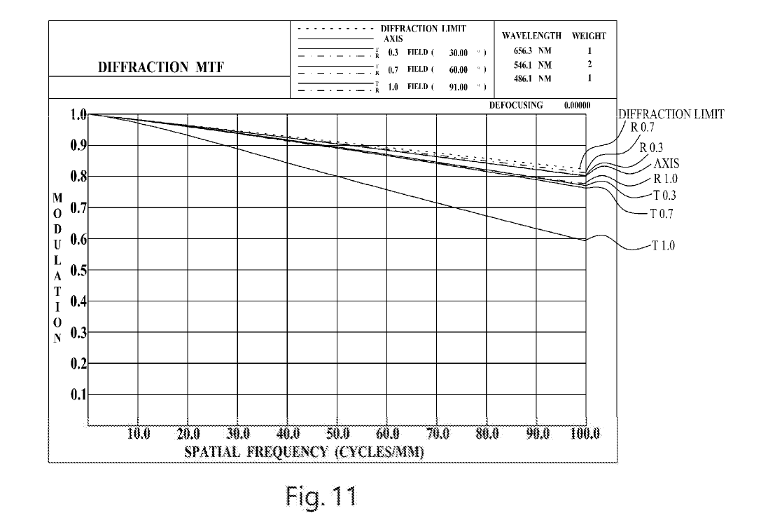

Performance of the present invention configured as described above is described in FIGS. 10 and 11.

FIG. 10 is a graph showing the spherical aberration and astigmatism of the wide-angle lens shown in FIG. 9, and FIG. 11 is a graph showing the MTF of the wide-angle lens shown in FIG. 9.

### Fourth Embodiment

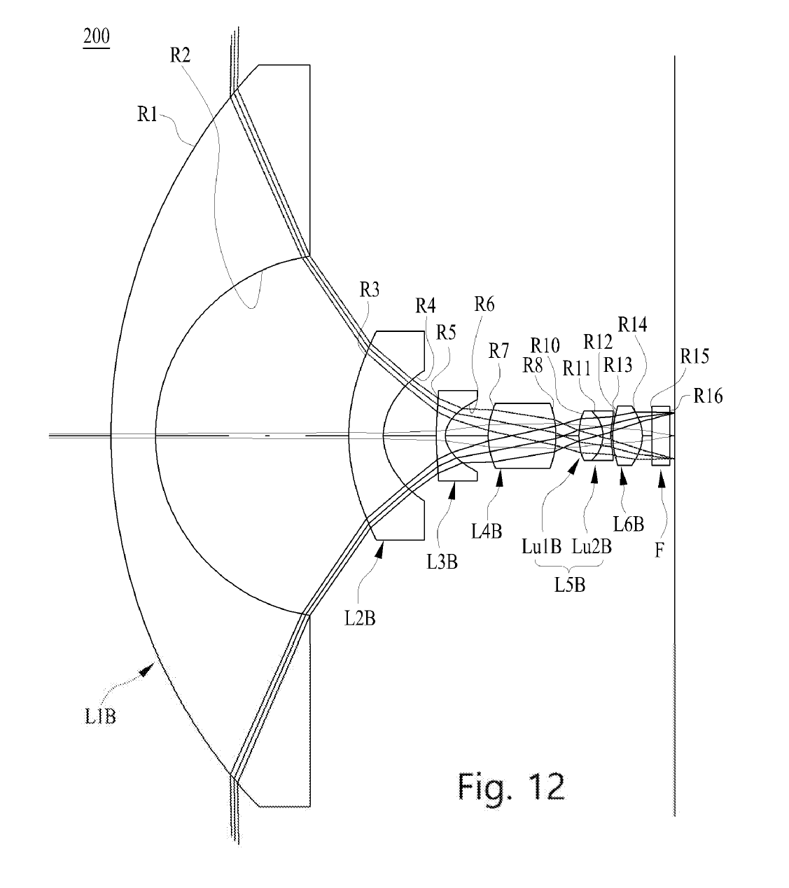

FIG. 12 is a cross-sectional view showing the configuration of a wide-angle lens according to a fourth embodiment of the present invention.

Referring to FIG. 12, the wide-angle lens 200 according to a fourth embodiment of the present invention includes a first lens L1B, a second lens L2B, a third lens L3B, a fourth lens L4B, a fifth lens L5B and a sixth lens L6B. Furthermore, the wide-angle lens 200 according to the present invention may further include a filter F.

A detailed description of the same elements as those of the previous embodiment is omitted, and only a different element is described.

The second lens L2B may include one or more aspherical surfaces.

It is preferred that each of the optical surfaces of the wide-angle lens shown in FIG. 12 has numerical values written in [Table 7] and [Table 8] below.

[Table 7] shows the basic data of the elements of the wide-angle lens.

TABLE 7
Basic lens data

| Surface | Curvature | Surface | Refractive | Index of |
|---|---|---|---|---|
| number | radius | interval | index | dispersion |
| Object | Infinity | Infinity | | |
| R1 | 30.32022 | 2.501525 | 1.734 | 51.49 |
| R2 | 10.20305 | 10.875336 | | |
| R3 | 10.62433 | 1.943317 | 1.743 | 49.32 |
| R4 | 3.25303 | 2.980309 | | |
| R5 | 15.25015 | 0.508160 | 1.545 | 56.00 |
| R6 | 1.26382 | 2.411009 | | |
| R7 | 4.06349 | 3.799634 | 1.6889 | 31.081 |
| R8 | −5.21447 | 0.425487 | | |
| Iris | Infinity | 0.869499 | | |
| R10 | 3.56544 | 1.346654 | 1.77 | 49.62 |
| R11 | −1.81714 | 0.451781 | 1.9228 | 20.88 |
| R12 | 4.37057 | 0.102766 | | |
| R13 | 3.85204 | 1.670670 | 1.545 | 56.00 |
| R14 | −2.03311 | 0.243757 | | |
| R15 | Infinity | 0.800000 | | |
| R16 | Infinity | 0.500000 | | |
| R17 | Infinity | 0.261977 | | |
| Image | Infinity | 0.000000 | | |

In this case, f1: −22.081

f2: −7.096

f4: 3.97

f6: 2.71

f: 0.60

v51: 49.62

v52: 20.88

n1: 1.734

v1: 51.49

[Table 8] shows the aspherical surface coefficient values of the lenses included in the fourth embodiment of the present invention.

TABLE 8

| Aspherical | | | | | | |
|---|---|---|---|---|---|---|
| surface | | | | | | |
| coefficient | K | A | B | C | D | E |
| R3 | 0.248921 | −0.994402E−04 | −0.449207E−05 | 0.315833E−09 | −0.673111E−09 | |
| R4 | −0.354193 | 0.239542E−02 | 0.189573E−04 | 0.183766E−05 | −0.615241E−06 | |
| R5 | 0.000000 | −0.262443E−02 | −0.594702E−04 | 0.857830E−05 | −0.337084E−06 | |
| R6 | −0.792041 | 0.238931E−02 | −0.343596E−02 | 0.524824E−03 | −0.856513E−04 | |
| R7 | −0.339112 | −0.963856E−03 | −0.534309E−04 | −0.299832E−04 | 0.252300E−05 | |
| R8 | −0.049773 | 0.302019E−04 | −0.872968E−04 | −0.113952E−04 | 0.406283E−05 | |
| R13 | −3.717290 | −0.141238E−01 | 0.598222E−02 | −0.110303E−02 | 0.000000E−00 | |
| R14 | −4.478213 | −0.288038E−01 | 0.837859E−02 | −0.204318E−02 | 0.538155E−03 | −0.830046E−04 |

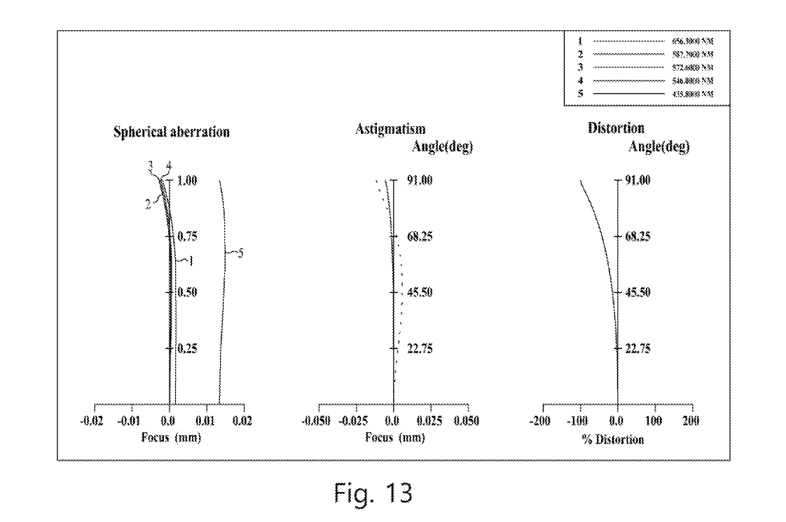

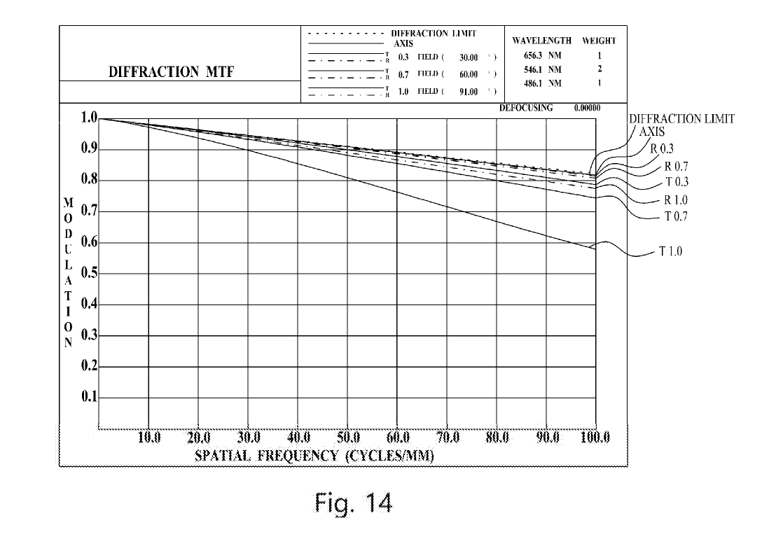

Performance of the present invention configured as described above is written in FIGS. 13 and 14.

FIG. 13 is a graph showing the spherical aberration and astigmatism of the wide-angle lens shown in FIG. 12, and FIG. 14 is a graph showing the MTF of the wide-angle lens shown in FIG. 12.

### Fifth Embodiment

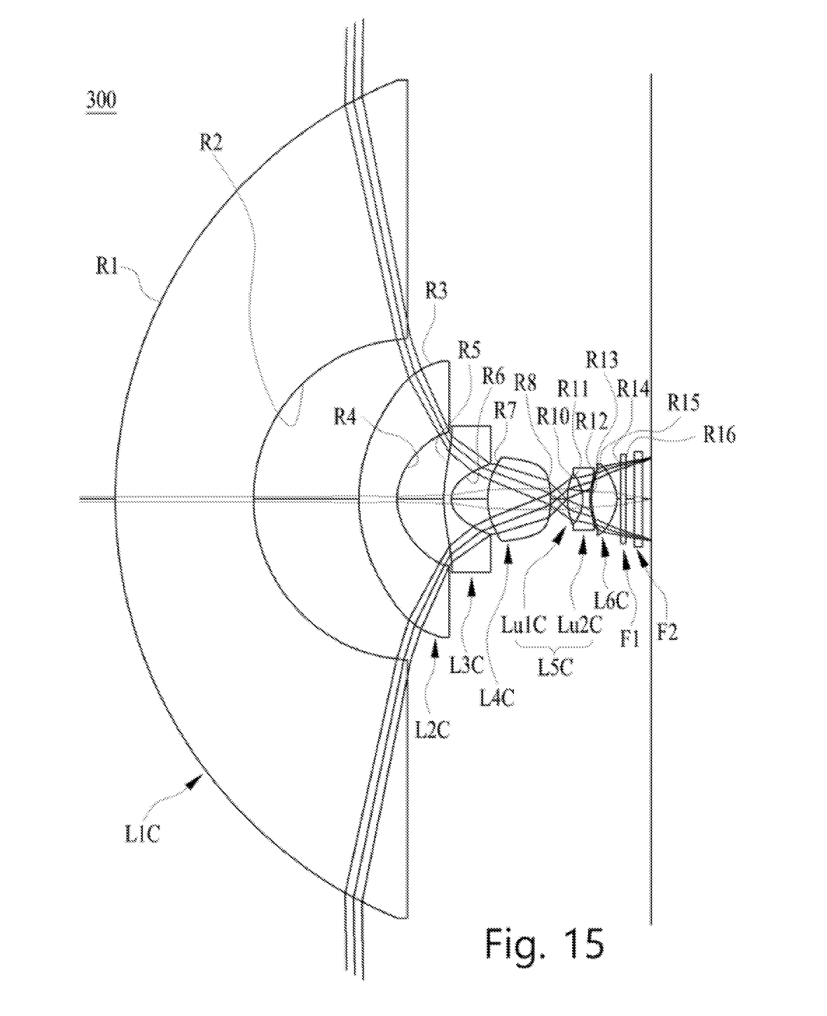

FIG. 15 is a cross-sectional view showing the configuration of a wide-angle lens according to a fifth embodiment of the present invention.

Referring to FIG. 15, the wide-angle lens 300 according to the fifth embodiment of the present invention includes a first lens L1C, a second lens L2C, a third lens L3C, a fourth lens L4C, a fifth lens L5C and a sixth lens L6C. Furthermore, the wide-angle lens 300 according to the present invention may further include first and second filters F1 and F2.

A detailed description of the same elements as those of the previous embodiment is omitted.

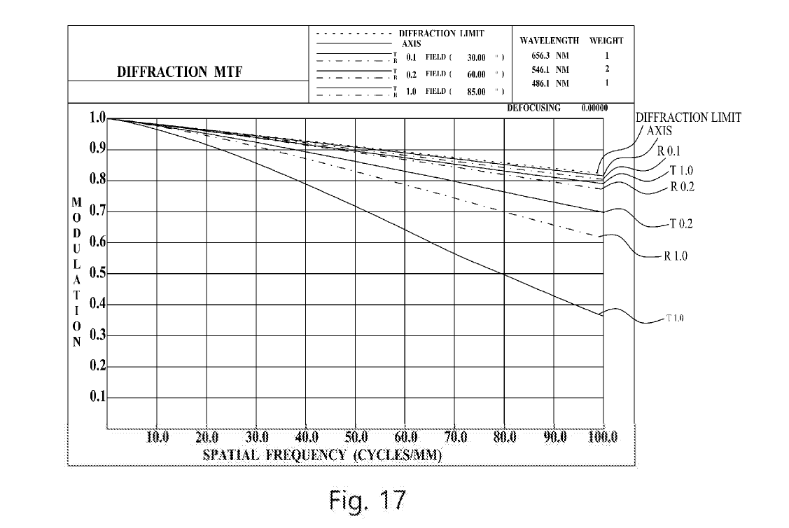

It is preferred that each of the optical surfaces of the wide-angle lens shown in FIG. 17 has numerical values written in [Table 9] and [Table 10] below.

[Table 9] shows the basic data of the elements of the wide-angle lens.

TABLE 9
Basic lens data

| Surface | Curvature | Surface | Refractive | Index of |
|---|---|---|---|---|
| number | radius | interval | index | dispersion |
| Object | Infinity | Infinity | | |
| R1 | 27.45358 | 8.380811 | 1.734 | 51.49 |
| R2 | 9.75954 | 6.387078 | | |
| R3 | 9.78551 | 2.315330 | 1.743 | 49.32 |
| R4 | 3.46666 | 2.830287 | | |
| R5 | 8.03945 | 0.450000 | 1.545 | 56.00 |
| R6 | 1.16427 | 2.206356 | | |
| R7 | 3.84626 | 3.820496 | 1.688 | 31.08 |
| R8 | −5.39038 | 0.367806 | | |
| Iris | Infinity | 0.658802 | | |
| R10 | 4.00650 | 0.907411 | 1.77 | 49.62 |
| R11 | −2.41026 | 0.450000 | 1.923 | 20.88 |
| R12 | 4.67892 | 0.100000 | | |
| R13 | 3.37880 | 1.521374 | 1.545 | 56.00 |
| R14 | −2.21942 | 0.243757 | | |
| R15 | Infinity | 0.300000 | 1.516 | 64.16 |
| R16 | Infinity | 1.374421 | | |
| Image | Infinity | 0.000000 | | |

In this case, f1: −25.76

f2: −8.54

f4: 3.91

f6: 2.716

f: 0.82

v51: 49.62

v52: 20.88

n1: 1.734

v1: 51.49

[Table 10] shows the aspherical surface coefficient values of the lenses included in the fifth embodiment of the present invention.

TABLE 10

| Aspherical | | | | | | |
|---|---|---|---|---|---|---|
| surface | | | | | | |
| coefficient | K | A | B | C | D | E |
| R3 | 0.305732 | −0.172982E−04 | −0.433021E−05 | −0.957343E−08 | 0.513261E−09 | |
| R4 | −0.303955 | −0.183617E−02 | 0.225284E−05 | 0.499752E−05 | −0.598571E−06 | |
| R5 | 0.000000 | −0.270825E−02 | −0.492362E−04 | 0.857830E−05 | −0.257580E−06 | |
| R6 | −0.792041 | 0.410823E−02 | −0.331331E−02 | 0.524824E−03 | −0.906878E−04 | |
| R7 | −0.251389 | −0.927037E−03 | 0.917318E−04 | −0.283103E−04 | −0.291450E−05 | |
| R8 | −0.405158 | 0.453587E−03 | −0.588980E−03 | −0.792851E−03 | −0.574043E−04 | |
| R13 | −3.717290 | −0.141238E−01 | 0.598222E−02 | −0.110303E−02 | 0.000000E−00 | |
| R14 | −4.478213 | −0.288038E−01 | 0.837859E−02 | −0.204318E−02 | 0.538155E−03 | −0.830046E−04 |

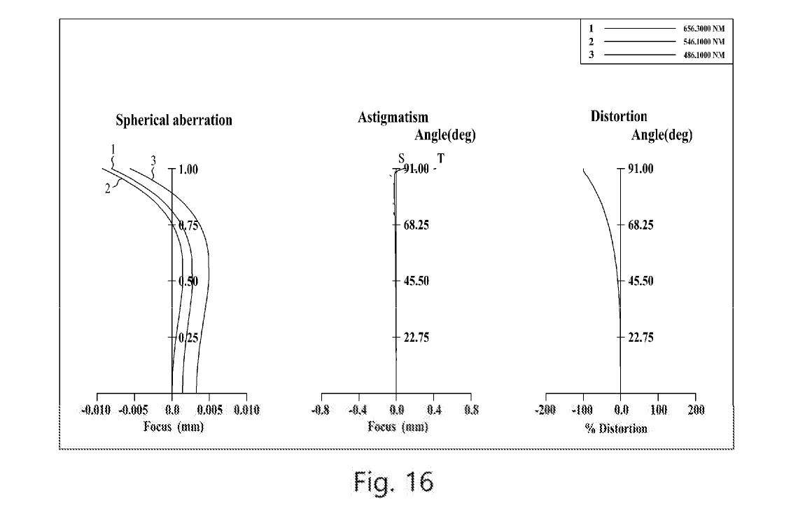

Performance of the present invention configured as described above is written in FIGS. 16 and 17.

FIG. 16 is a graph showing the spherical aberration and astigmatism of the wide-angle lens shown in FIG. 15, and FIG. 17 is a graph showing the MTF of the wide-angle lens shown in FIG. 15.

In the aforementioned embodiments 3 to 5, the aspherical surface may be converted by [Equation 16] below.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad [ Equation 16 ]$$

In this case, c=1/radius.

In accordance with the present invention including the aforementioned embodiments, an angle of view of 180 degrees or more can be achieved, a less number of lenses can be included, and reliability can be secured even in outdoor activities.

Although the present invention has been described with reference to the embodiments illustrated in the drawings, the embodiments are only illustrative. A person having ordinary skill in the art will understand that other modifications and equivalent other embodiments are possible from the present invention. Accordingly, the true technical scope of protection of the present invention should be determined by the technical spirit of the attached claims.

1. A wide-angle lens, comprising:
a first lens having a negative (−) refractive index, the first lens being a meniscus lens in which a surface facing an object is convex toward the object and a surface facing an image is concave;
a second lens disposed behind the first lens and having a negative (−) refractive index, the second lens being a meniscus lens in which a surface facing the first lens is convex toward the first lens and a surface facing the image is concave;
a third lens disposed behind the second lens and having a negative (−) refractive index, the third lens being a lens in which a surface facing the image is concave;
a fourth lens disposed behind the third lens and having a positive (+) refractive index, both surfaces of the fourth lens being convex;
a fifth lens disposed behind the fourth lens, but disposed toward the object, the fifth lens being configured by jointing a third unit lens having a positive (+) refractive index and a fourth unit lens having a negative (−) refractive index together; and
a sixth lens disposed behind the fifth lens and having a positive (+) refractive index, both surfaces of the sixth lens being convex

2. The wide-angle lens of claim 1, wherein the fourth lens is configured by joining a first unit lens having a positive (+) refractive index and a second unit lens of a meniscus form together.

3. The wide-angle lens of claim 2, wherein both surfaces of each of the first lens and the second lens are spherical surfaces.

4. The wide-angle lens of claim 3, wherein in the fourth unit lens of the fifth lens, a surface facing the image is concave.

5. The wide-angle lens of claim 4, wherein the third lens comprises one or more aspherical surfaces.

6. The wide-angle lens of claim 5, wherein the sixth lens comprises one or more aspherical surfaces.

7. The wide-angle lens of any one of claim 1, wherein the first lens and the second lens satisfy [Equation 1] below.
1.5<|f1/f2|<4.0 [Equation 1]
f1: a focal distance of the first lens
f2: a focal distance of the second lens

8. The wide-angle lens of claim 7, wherein the fifth lens satisfies [Equation 3] below.
20<v53−v54<40 [Equation 3]
v53: an Abbe number of the third unit lens of the fifth lens
v54: an Abbe number of the fourth unit lens of the fifth lens

9. The wide-angle lens of claim 8, wherein coefficients of thermal expansion of the third lens and the sixth lens satisfy [Equation 2] and [Equation 5] below.

|A3|>1.6×10⁻⁵ [Equation 2]

|A6|>1.6×10⁻⁵ [Equation 5]
A3: the coefficient of thermal expansion of the third lens
A6: the coefficient of thermal expansion of the sixth lens

10. The wide-angle lens of claim 9, wherein refractive indices of the third lens and the sixth lens satisfy [Equation 6] below.

|n3−n6|<0.2 [Equation 6]
n3: the refractive index of the third lens
n6: the refractive index of the sixth lens

11. The wide-angle lens of claim 10, wherein the first lens satisfies [Equation 9] and [Equation 10] below.
1.55<n1<1.85 [Equation 9]
n1: a refractive index of the first lens in a wavelength 587 nm
40<v1<80 [Equation 10]
v1: an Abbe number of the first lens

12. The wide-angle lens of claim 11, wherein the fourth lens and the sixth lens satisfy [Equation 13] below.
1.0<f4/f6<2.0 [Equation 13]
f4: a focal distance of the fourth lens
f6: a focal distance of the sixth lens

13. The wide-angle lens of claim 12, wherein the sixth lens satisfies [Equation 14] below.
2.0<f6/f<5.0 [Equation 14]
f6: a focal distance of the sixth lens
f: a focal distance of the wide-angle lens.
